(19) United States
(12) Patent Application Publication
(10) Pub. No.: US 2003/0078864 A1
(43) Pub. Date: Apr. 24, 2003

(54) Financial transaction system with saving benefit

(76) Inventors: Laurence D. Hardesty, Buckeye, AZ (US); David E. Shein, Paradise Valley, AZ (US)

Correspondence Address: Gregory J. Nelson, NELSON & ROEDIGER, 3333 E. Camelback Road, Suite 212, Phoenix, AZ, 85018, US

(21) Appl. No.: 09/747,117

(22) Filed: Dec. 22, 2000

Related U.S. Application Data
(63) Continuation-in-part of application No. 09/619,806, filed on Jul. 20, 2000.
Application No. 09/619,806 is a continuation of application No. 09/118,438, filed on Jul. 17, 1998, now Pat. No. 6,105,865.

(51) Int. Cl. G06F 17/60

(52) U.S. Cl. 705/35

(57) ABSTRACT

A rebate program for the benefit of participating individuals such as wage earners. Participating individuals apply and are approved and are issued a card with an identifiable account number using credit approval systems. The card may be a debit, smart card, customer loyalty and security features. The rebate is calculated and transferred to the participant's account in a trust fund. The card may also be used to engage in other financial transactions. The system may include a wide range of retail merchants as well as professional services available to the participant. Funds are disbursed to the participant upon the occurrence of certain specified events.

This application is a continuation-in-part of Ser. No. 09/619,806, filed Jul. 20, 2000, which is a continuation of Ser. No. 09/118,438, filed Jul. 17, 1998, now U.S. Pat. No. 6,105,865, issued Aug. 20, 2000.

### FIELD OF THE INVENTION

The present invention relates to a financial system and more particularly relates to a financial transaction processing and management system for acquiring data and creating, funding and administering a large pool of accounts which are established and held for the benefit of consumers that elect to participate in the resulting benefit program. The investment accounts are funded by benefit sponsors when participating consumers purchase goods or services or engage in other qualified behavior. The system is of particular benefit to the individual or household that may not be adequately providing for retirement or other significant future expenses.

### BACKGROUND OF THE INVENTION

The current economy continues to move rapidly toward cashless (electronic) modes and devices for the fulfillment of both consumer and commercial transactions. The most common cashless device is the payment card or “plastic” as it is commonly called. Generally, payment cards are issued by a bank or financial institution under license from an organization such as Visa® or MasterCard®. Payment cards may also be issued directly by organizations such as Discover® and American Express®. In all cases, the issuing entities establish networks of merchants that accept the cards. Banks, payment card processors and other market participants service the accounts, fund, clear and settle the transactions and manage the dispute resolution processes. Consumers can then use the payment cards to purchase goods and services from merchants. The merchants, in turn, pay a percentage of the transaction, usually between 1.75% and 2.75%, to the various institutions participating in the integrated payment card enterprise relating to that transaction.

In order to promote the use of a particular payment card and to induce merchants to participate in the resulting enterprise by accepting payment cards as a form of payment, payment card issuers rely on a wide variety of marketing tools and advertising techniques. For example, some payment card companies offer special discounts to card users if they buy particular products or services. Other payment card issuers offer airline frequent flyer miles or “points” redeemable for goods and services and yet other card issuers, such as Discover®, rebate a small percentage of each qualifying purchase to the consumer, typically in the order of one or two percent. Other types of promotional devices include future shopping credits based on payment card activity, which may be used when purchasing large ticket items such as appliances or vehicles.

In addition to the conventional payment card, other types of non-payment cards are used in consumer transactions. More and more merchants, such as grocery store chains, are issuing customers cards known as shopper loyalty cards and frequent shopper cards. These businesses promote use of these cards as an incentive to shop frequently and a convenient alternative to paper coupons. The object of these non-payment cards, similar to the frequent flyer programs run by certain payment card issuers, is to build loyalty by offering customers discounts and incentives. The customer presents the card to the merchant at the time of purchase, the card is scanned and certain items are discounted.

The advantage to the merchant is that such cards utilize a database which permits the merchant to track and reward the shopping habits of a particular customer, permitting the delivery of targeted offers and eliminating the need for checkout cashiers to visually and electronically scan coupons. Like their payment card counterparts, these non-payment vehicles build customer loyalty and facilitate the collection of information on shoppers' buying habits, preferences and demographics, thereby providing the merchant with valuable demographic and product information which will assist in the marketing and development of both new and existing products and services.

Recently, the marketplace has witnessed the introduction of Internet loyalty and reward programs that provide a variety of incentives to consumers to purchase specific goods and services either on or off-line or to “visit” certain web sites. These programs permit consumers to use a variety of electronic payment methods, including the secure delivery of payment card information, Internet or electronic wallets and cyber-currency. Like their counterparts in the brick and mortar world, however, these programs offer incentives that are essentially limited to discounts, “points” and “airline miles.”

Other types of payment cards are known as SMART cards or e-cards. These cards are also an alternative to the use of hard currency. A SMART card stores information digitally and, in some cases, incorporates the ability to interact with third-party computers or point of sale devises. SMART cards of the relatively simple type produced by Productivity Enhancement Products of Laguna Hills, Calif. work like an automated teller. These cards are personalized and protected by an identification system, typically a PIN number or a photo. The cards function like cash with their value stored on a computer chip embedded on the card, which stored value is reduced by the amount of the purchase at the time of use. Merchants may then use P.C. based cash registers to deduct payments from the cards. SMART cards can be used to buy items and cards of this type are commonly used by students for purchasing meals at university cafeterias and are promoted for use in making long distance telephone calls. Other SMART cards are significantly more sophisticated and robust in their capabilities and represent a rapidly growing trend and opportunity in the worldwide payment card enterprise.

Commonly used payment cards also include debit cards, both on-line and off-line, which are presented at the point of sale, and electronically “swiped”. The user may then authorize a direct deduction from a checking or savings account in the amount of the purchase or an amount that includes additional cash back to the user.

In the United States today, an increasing plurality of consumers actively use payment cards or related electronic means of one type or another to purchase goods and services. Payment cards are used as a convenience (to consolidate monthly reporting and to avoid a consumer having to carry large quantities of cash), as a source of consumer credit, as a source of intrinsic benefits such as airline miles or shopping “points” or some combination of the foregoing. Regardless of the motivating force, however, both the percent and dollar volume of all consumer transactions that are facilitated by payment cards of all types continues to grow every year.

At the same time payment card use has been increasing, household savings rates in the United States continue to decrease and, in fact, are reaching all time lows. This situation is of particular concern to many American households in today's environment of uncertainty regarding the long-term viability of the Social Security System and increasing education and medical expenses.

Studies show that millions of American households have not and are not adequately providing for retirement or other significant expenses. Further, government and private studies predict that the Social Security system will experience financial problems within the next fifteen years. According to the trustees, the United States Social Security system will actually become insolvent by the year 2029 if the government does not take remedial steps. Even if the financial difficulties of the present Social Security system can be fixed, the “fix” will most likely involve either an increase in taxes (further eroding savings rates) or a diminution in benefits (further exacerbating the retirement savings problem itself). Accordingly, it becomes more and more incumbent upon consumers to plan for their own retirement in order to ensure a secure future. This will only occur if overall household savings rates are increased.

Studies have also shown that workers born in 1950 can expect approximately $631 per month from Social Security. Had that worker instead invested his payroll tax in a 50—50 mix of government and corporate bonds, his monthly retirement income would have been approximately $1,069 per month. Had that same worker invested in a stock portfolio of 75% large capitalization companies and 25% small cap companies, he would receive monthly income of approximately $2,419 per month. Studies have also shown that Americans are becoming increasingly aware of their lack of personal savings and the potential shortfalls of the Social Security System and are receptive to alternative savings vehicles.

The present invention leverages the ever-expanding use of payment cards and other electronic payment means by American consumers and the proliferation of traditional loyalty and reward programs, to address a fundamental problem facing a plurality of American households: How to create and implement a long-term savings plan.

Various rebate and refund systems can be found both in the prior art and patent literature. For example, U.S. Pat. No. 4,750,119 describes a purchasing system with a rebate feature, which allows for the input of purchase orders and correlates transfer of funds from purchasers to vendors. A future benefit guarantor supplies the rebate factor, which is input into the system. The system then computes and reports the rebate, which is due in the future to each subscriber or purchaser. The system provides instructions to pay the vendors for selected goods and services and pay the future rebate guarantor a premium representing the purchase price of future guaranteed rebates. Preferably the premium is paid on a daily basis to the guarantor and a group annuity contract is funded.

U.S. Pat. No. 4,941,090 shows a centralized computer cash value accumulation system based on point of sale transactions with multiple merchants. The consumer's account number and birth date are transmitted to a central system along with data identifying the merchant and a credit line determined by the merchant. At the central location, a cash value for that consumer is incremented by the credit value and a bill for that merchant is similarly incremented. Periodically the merchants are billed for the accumulated bill value. Also at selected intervals, consumers are given access to their respective accumulated cash values by either check or through funds dispensed electronically. Preferably the intervals are selected to correspond to the birth dates of the consumers.

U.S. Pat. No. 5,537,314 shows a credit accumulation and accessing system for a plurality of sponsors and participants. Under the control of an operational program, several tasks are accomplished including creating sub-directories for a single participant account so as to selectively associate the single account sub-directory with multiple sponsoring company accounts in deciphering and, accordingly at points of sale, calculating, posting and issuing discounts, raffle entries, store credit returns, points and cash values in accordance with the performance of participants. Award output devices provide consumers with access to funds based upon the cash value in the consumer account and may include wire transfer, check, cash coupon, payment card balance reduction or catalog merchandise.

In addition, U.S. Pat. Nos. 6,009,412 and 6,014,634 and 6,061,660 all describe methods and systems for conducting and supporting consumer loyalty and reward programs.

It is important to note that neither the prior art nor existing consumer loyalty and reward programs in the market today focus on, address or attempt to resolve the growing inability of a plurality of American households to independently and successfully save for retirement or other major future expense through the use of tax-deferred investment accounts.

Accordingly, the present invention differs substantially from the prior art and is based on two underlying principles: (a) that consumers today are more acutely aware than ever that personal savings are and will remain an increasingly important component of a safe and secure retirement and future; and (b) that merchants, payment card issuers and a wide variety of other market participants are willing, as a sales inducement and loyalty and marketing opportunity, to pay a portion of each qualified transaction into a tax deferred investment account for the benefit of the participating consumer. These two principles combine to form the basis for the present invention, which benefits both business and the consumer.

The benefit offered to participating consumers is unique and, by definition, the duration and nature of the customer relationship offered to benefit sponsors extends further than any other program available today. For young consumers saving for retirement or other permitted expenditure, the relationship spans decades. For older consumers helping children and grandchildren save for the future, the relationships span generations. For all consumers, the nature of the benefit transcends ‘points,’ ‘miles’ or simple cash discounts, all of which have become undifferentiated commodities in today's marketplace.

In sum, for those Americans who have difficulty creating or maintaining a long term saving plan or are vulnerable to the potential loss or diminution of Social Security benefits, this invention provides a new, unique and novel opportunity to accumulate meaningful savings, without changing current spending levels or habits or sacrificing existing quality of life. The system will be implemented without new or additional legislation and it will leverage, to the greatest extent possible, existing technology, payment means, electronic communication and data processing systems.

### BRIEF SUMMARY OF THE INVENTION

Accordingly, in one aspect, the present invention provides a system based on a payment card for financial transactions which with some modification will utilize the existing financial structure and existing computer software and hardware so that over a period of time, a portion of funds spent by users utilizing the payment card will be deposited into a depository such as a trust fund. Funds so deposited over the working life time of an individual will be allowed to accumulate and can only be withdrawn upon retirement or some other event such as medical emergency and either on a tax-free or tax deferred basis.

The present invention provides a system in which an individual is issued a special payment type card which in one embodiment is designated a “Retirement Charge Card” (RCC). The user will have an identifiable account in a trust fund and the RCC would be issued by banks or other existing financial institutions. Individuals, upon consummating transactions such as credit purchases using the card, would be rewarded with a rebate in a predetermined about, which rebate would not go directly to the individual card holder but rather would be deposited into the card holder's trust fund account. The invention contemplates using existing electronic credit and banking systems for approval both approving the issuance of cards and approving individual transactions.

The result will be that those using the cards would tend to be financially responsible individuals and therefore the rate of delinquency or loss on the cards to card issuers and businesses would be substantially reduced. Use of the cards would benefit businesses in that card holders would tend to make more purchases on their cards, thus increasing the revenue to the businesses and banks. The system may be implemented without additional legislation using existing technology, electronic communication and data processing systems.

As an additional feature, those businesses honoring the cards could also be provided with conventional banking software and have one or more checkout locations at which the software is available creating a virtual banking system which would substantially reduce transaction costs to banking institutions. Thus, card holders could utilize these checkout locations when purchasing goods or services. Further, these locations could provide other banking services such as deposits, bill payment and the like, thus providing convenience to card holders and providing more convenient banking locations and reducing overhead and operating expenses to banks.

The trust fund will issue periodic statements to the card holders setting forth the amount in the trust. The funds will be treated as trust funds and deposited in investments such as government securities, bonds, and perhaps blue chip stocks. As another aspect of the system, the individual card holder may select from a menu of securities such as high growth stocks, bonds, government securities or blue chip stocks and select the particular areas in which the funds deposited to the card holder's account would be invested.

Another significant advantage of the transaction system of the present invention is that the system inherently provides a safeguard for as inflation occurs over a period of time and as the card holder spends more, increased retirement savings will be effected as the rebate is based on a percentage of the amount spent.

The system further contemplates expanding services available to participants by providing additional services such as low cost loans, appraisal services, insurance services, provided by entities funded by the trust fund. Stock in these companies would be available to member participants.

The present invention will permit participating consumers save for retirement or other permitted expenses by directing a portion of every qualifying purchase to a private, tax-deferred investment account. Participating consumers may also receive investment account benefits for engaging in certain non-spending behaviors such as directed web surfing or recycling.

The present invention will also permit benefit sponsors to establish and maintain long duration, extremely cost effective consumer relationships. Benefit sponsors may include payment card issuers, merchants, service providers, manufactures, financial institutions and a host of other market participants. In exchange for making deposits (or arranging to make deposits) into the investment accounts of participating consumers upon the occurrence of specified or qualifying events, benefit sponsors will obtain a direct and intimate connection to a vitally important consumer base and segment of the American retail economy.

The system will leverage and utilize existing Internet advertising and on-line commerce platforms and technologies and payment card issuing and acquiring processing and off-line point of sale platforms and technologies to the greatest extent practicable. Utilizing secure data transmission facilities, the system will harvest all data required to administer the resulting program from various points throughout the entire commercial enterprise including, without limitation, payment card issuers and their designated issuing processors, merchants and service providers and their designated acquiring processors, manufacturers, financial institutions, Internet portals and a wide variety of present and future benefit sponsors that do not fall neatly into any of the foregoing categories.

The program that results from the system described herein will be operated and administered by a “program manager.” Except for the investment accounts actually held and administered by fiduciary(ies) on behalf of participating consumers, a program manager will maintain complete responsibility for the coordination and management of all aspects of the program, including, without limitation, the operation of the system.

The system will permit all consumers to participate on a variety of levels, utilizing a variety of methods to pay for goods and services. The preferred payment method contemplates the use of a payment card (for example, Visa®, MasterCard® or American Express®) issued by a benefit sponsor with a “BIN” or other number or feature unique to the system. Participating consumers will apply for the referenced card and, upon approval, utilize the card to purchase goods and services in the same manner they would any other payment card. This method will permit the participating consumer to receive the widest variety and most comprehensive list of investment account benefits. As the program matures, consumers will also be able to participate utilizing their existing payment card(s) or cash or check; provided, however, that participating consumers that rely exclusively on these payment methods will have access to a smaller sub-set of investment account benefits.

The system will permit payment card issuers, merchants, payment card processors, merchant acquiring institutions, banks, service providers, manufactures and an essentially infinite variety of other business entities to participate as benefit sponsors and to offer benefits to participating consumers in the form of investment account deposits. The system's open architecture and ability to accept and assimilate data from diverse sources, places very few limitations on benefit sponsor participation. The primary requirement will be the desire to reward participating consumers for engaging in specified behaviors by making a deposit into a participating consumer's investment account. In connection with participation, benefit sponsors will be entitled to communicate with participating consumers in a variety of ways, discussed in greater detail below.

The participating consumers' investment accounts will be held and administered by a fiduciary and have federal and state income tax attributes that will permit the participating consumer to receive deposits of principal and accumulate income on a tax-deferred basis for retirement or other permitted uses. Periodically, as funds are collected from benefit sponsors or their designated agents, the program manager will deliver (or arrange for the delivery of) the funds to the third party fiduciary, together with appropriate instruction directing the fiduciary to credit the correct amount(s) to each participating consumer.

The system and method will incorporate comprehensive audit, reconciliation and reporting capabilities that will comply in all respects with: (a) Generally Accepted Accounting Principals (GAAP); and (b) Federal, state and local regulations relating to the creation and maintenance of, and distributions from, tax-deferred investment vehicles. The system and method will also incorporate comprehensive periodic and customizable reporting for both participating consumers and benefit sponsors using established communication systems, which may include, but are not limited to, mail, phone, Internet, digital, wireless and satellite communication devises.

The system will employ a variety of modes for communicating with participating consumers regarding special offers and other incentives and benefit sponsor communications, including, without limitation, periodic statements, piggyback communications (communications delivered with third party or other benefit sponsor communications), Internet web pages and hyper-links, directed e-mail, broadcast fax and print, radio and television media. Benefit sponsors will utilize these modes, as well as approved independent modes, to communicate opportunities and special incentives to participating consumers. Consumer responses may then be tracked and monitored and highly refined and accurate reports generated for benefit sponsors.

### BRIEF DESCRIPTION OF THE DRAWINGS

The above and additional features and advantages will become more readily apparent from the following detailed description of the invention taken in conjunction with the drawings in which:

FIG. 1 is a schematic diagram showing an embodiment of the present invention;

FIG. 2 shows a typical payment card;

FIG. 3 is a schematic diagram providing a general overview of the data sources, systems and components of another embodiment of the financial transaction system of the present invention;

FIG. 4 is a schematic diagram depicting the system as it relates to participating consumers and benefit sponsors;

FIG. 5 is a schematic diagram depicting the flow of funds and custodial investment accounts; and

FIG. 6 is a schematic diagram depicting the overall relationship between the participating consumer and the various benefit sponsors.

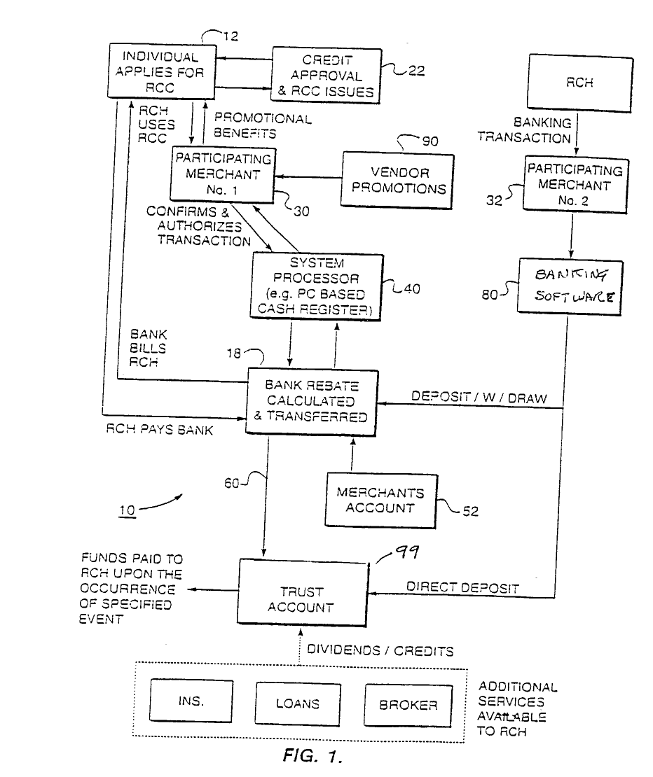

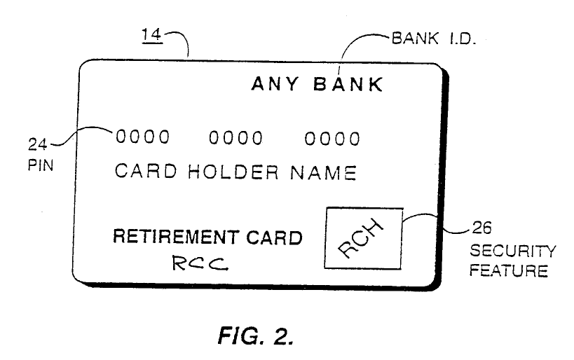

Referring now to FIG. 1, there is shown a financial processing system 10 in which a predetermined percent of expenditures are rebated to the consumer in the form of deposits into a trust account. The portion of the transaction which is credited to the member is termed a “rebate” which implies that ownership of this amount is transferred to a financial institution and then credited back to the member. The term “rebate” also includes amounts which are considered to remain the members and which are passed through the system for the member's benefits. The system is generally designated by the numeral 10 and each member or participant 12 is designated as a retirement card holder which for purposes of this embodiment each is designated as an “RCH”. Each RCH applies for and upon approval would be issued an RCC card 14 as seen in FIG. 2 at numeral 22. Existing credit reporting agencies such as Equifax and TRW can be utilized for approval of applicants. The RCC card 14 would be issued by a bank or other organization 18. The applicant provides the usual information which is processed by a credit approval computer 22 which checks credit records and which using prescribed standards approves the applicant as an RCH.

Upon approval of an RCC card, as shown in FIG. 2, will carry an identifiable account number 24 which would be personal to the card holder. The account number may correspond to the user's social security number of the card holder or may be some other PIN. The card has characteristics of a credit card with a predetermined spending limit issued by a bank or other organization as is conventional or could also be a SMART card which the RCH would purchase and would electronically store funds up to a certain amount. A SMART card would include a verification number and a de-encryption algorithm for security. Security can also be provided by other verification techniques such as biometrics. Security features 26 such as photograph, thumb print or some other security feature such as a microchip may be included to ensure that only the authorized RCH may utilize the card. The card may include other features such as debit features to allow the card holder to debit selected accounts upon the purchase of goods or services. The RCC will also authorize the RCH to access various accounts and perform various transactions.

Benefits also accrue to merchants as participating merchants would advertise that they accept the retirement card which would enhance the business and attract additional business and customers. Participating merchants 30, 32 may be conventional retail merchants such as supermarkets, department stores, restaurants and the like or even professionals such as lawyers, doctors and accountants. In addition, participating merchants may also be less traditional merchants such as casinos where the card holder may purchase casino credits in a predetermined amount. Thus, those merchants that participate by accepting the card could experience increased business by appealing to a broader segment of the consuming society. Users will tend to place more expenditures on the card since they will, by doing so, add to their retirement funds.

For example, the card holder could use the retirement card at a retail location such as a department store represented by the numeral 30. By using the card, the card holder may charge the purchase. The merchant will process the purchase using a PC based processing system on a centralized computer 40 and obtain authorization using either existing charge authorization or a similar system established for the system. The user can charge goods and services offered by those accepting the RCC. At the end of a business cycle, for example at the end of the day, the merchant will then make a deposit, either physically or electronically, with the merchant's bank 18 including those credit sales which were purchased by customers using the retirement card. The bank 18 will credit the merchant's account 52 with an amount which represents the amount of the sale less certain costs of the transaction including any fees that the merchant has agreed to pay the underwriting or card-issuing organization such as VISA®, MASTERCARD® or DISCOVER® card. The calculation of the rebate and transfer of funds occur electronically using existing banking systems or systems using electronic transfer established for this purpose. In addition, the bank 18 will transfer a predetermined percentage of the transaction to a trust account 99. The predetermined percentage, termed a rebate 60, is calculated by an established formula based on the transaction and typically would be between 2 and 5 percent.

The retirement trust account 99 is a professionally managed fund and amounts that are transferred will be credited to the card holder's retirement account using the card holder's account designation such as the PIN 24 assigned to the particular card holder. Periodically, the card holder will receive a statement from the issuing bank reflecting charges for a billing cycle as, for example, over a thirty day period. The card holder will then pay the amount billed or at least a minimum monthly fee to the bank.

The advantages of the system 10 are many. The system is driven to some extent by the individual card holder's desire to be able to make purchases conveniently using the card 14 and also by the card holder's concern for a more secure financial future. Businesses will benefit as the system will generate a larger customer base and increased sales. As pointed out above, there is a built-in hedge against inflation as credits or rebates are based on a percentage of sales amounts. Losses would be low as those individuals who would be issued cards would tend to be financially responsible individuals of the type that are concerned about their financial future. Transaction costs could be minimized since losses and delinquencies will inherently be lower. In addition, costs of the system could be offset by advertising income that would accompany statements sent to the card holders. For example, special discounts on promotions of goods and services offered by vendors 90 of such goods and services could accompany periodic statements issued to the card holder. Goods and services can also be promoted through value card-type promotions which would also serve to increase customer loyalty and result in savings to customers who purchase specially promoted goods and services. These vendor promotions can be available directly to the participant at the time of check-out in the form of discounts on selected items.

The card holder is preferably provided a menu from which the card holder could select the type of investments to be made with the card holder's funds on deposit in the trust fund 99. These funds would be professionally managed and would broadly be categorized as a high, medium or low yield investment or a mixture of such investments depending upon the objectives and personal preference of the individual card holder. Lower yield investments would traditionally be a bit more secure and would be such items as government securities. Medium yield investments would be quality corporate bonds whereas the high yield investment would generally be made in stocks such as blue chip stocks or perhaps mid-cap stocks. The result is privatization of retirement funding. Significant advantages would be that the system would relieve the pressure from the faulty social security system and, at the same time, increase benefits to participants.

Studies have shown that workers born in 1950, using rates of return on stocks and bonds that are lower than actual returns, a low income worker can expect $631 per month from social security. Had that worker instead invested his payroll tax in a 50—50 mix of government and corporate bonds, his monthly retirement income would have been $1,069 per month. Had this worker invested in a stock portfolio of 75% large capitalization companies and 25% small cap companies, he would receive a monthly income of $2,419 per month.

The participating businesses, in order to attract more customers and also to reduce the transaction costs and to provide convenience to the customers, may offer a number of other services as indicated in FIG. 1. Instead of simply serving as a provider of goods and services established retail businesses such as department stores, supermarkets and other merchants could also provide a large range of banking services. As indicated above, a participating merchant such as a supermarket represented by the numeral 32 may provide special checkout aisles for participating individuals. The customer may by use of the card 14 to purchase items. In addition, since the account is a specifically identifiable account, the merchant may install conventionally available banking software to allow the RCH to make deposits into banking or checking accounts, cash checks, transfer funds between accounts and perhaps make payments for such items as utilities and installment payments.

Thus, each user or subscriber of the system may participate in various investments and can utilize the card for convenient access to other banking services. The card can be used not only for purchases of goods and more conventional services but can also be used to purchase professional services such as services of accountants, lawyers, doctors, dentists and the like. Individuals may also use the card for making donations to designated beneficiaries such as charities.

The funds in the participant's account 99 would be distributed upon the occurrence of a specific event such as the individual reaching a specified age and preferably tax laws will allow the distribution to be either tax deferred or tax free. Implementing regulations may also provide for early distribution if a specified need arises such as a medical or educational expense.

### EXAMPLE

The following are examples of the benefits to a participating member who spends $25,000 per year using the card 14 for an average of twenty-five years based on a 5% rebate:

@ 6% the trust account would be worth $72,189.18

@ 7% the trust account would be worth $84,385.17

@ 8% the trust account would be worth $99,068.42

The annual spending figures of $25,000 is not excessive as average amount annually on food, utilities, clothing, insurance, transportation, travel, entertainment and housing. Since a significant benefit occurs, users would simply have to discipline themselves to use the card and pay off balances monthly.

The system can also be expanded as shown in FIG. 1 to provide the participating members other services. The trust fund will accumulate a huge sum of money which will be administered by a board of trustees. Some funds may be used to establish businesses such as banks, brokerage houses, insurance companies, appraisal firms, accounting firms which may be utilized by RCH's at substantial savings. Profits from these businesses could thus be returned to the member who utilized these services in the form of dividends or additional credits to the member's trust fund account based on participation. The business can be corporations in which the members may buy stock or may be established as cooperative ventures depending on existing laws and regulations. It may be that special enabling legislation may be required to establish certain features of the system.

The issuance of cards is not restricted to nationals, thus, use of the card by non-residents would result in funds flowing into the country which would have a favorable effect on the balance of trade.

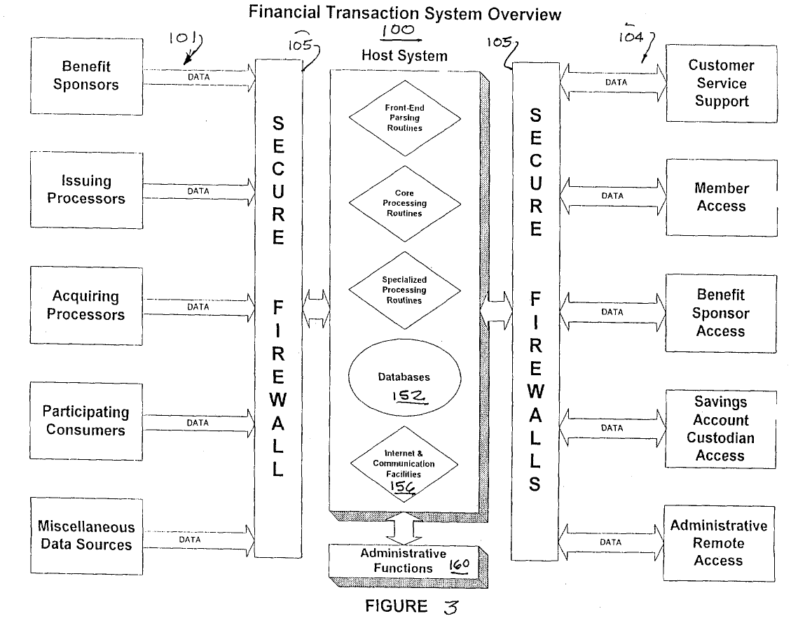

Turning now to FIGS. 3 through 6, another embodiment of the present invention is shown which is designated by the numeral 100. Embodiment 100 contemplates the creation of a highly efficient, broad-based, consumer shopping and loyalty program in which the benefit to the participating consumer will comprise periodic deposits into an investment account that will be managed by a third party fiduciary and will hold principal and accumulate income on a tax-deferred basis. The deposits will be funded by benefit sponsors based on the participating consumer's purchasing activity and other qualifying behavior.

In addition to downloading, accepting, processing and storing all of the data and other inputs necessary to manage and operate the program, the system will: (a) maintain detailed records of participating consumers and their level(s) of participation; (b) maintain detailed records of benefit sponsors, their level(s) of participation and benefits offered; and (c) track, manage, account for and report on each event that results in a participating consumer becoming entitled to receive an investment account deposit or disbursement.

The system will also provide appropriate and comprehensive periodic reporting to participating consumers and benefit sponsors. The system will operate on high quality commercial grade P.C. hardware, using a stable, robust, commercially available database such as Microsoft SQL Server or Oracle with proprietary programs and routines developed using stable, robust, commercially available tools such as Microsoft Visual Basic, Microsoft Visual C++, Microsoft Visual J++ and Sun Microsystems Java.

Referring to FIG. 3, there is shown a general overview of the financial transaction processing, tracking, reporting, accounting and management systems that comprise the present invention. As FIG. 3 shows, input data 101 is harvested from sources including consumers, financial institutions such as issuing and acquiring processors, benefit sponsors or the benefit sponsors' designated data sources and delivered to the host processing system 150. The host processing system 150 then parses the input data into its various component parts for delivery into the appropriate data bases and warehouses that reside within the system 102 for further processing and storage, as the case may be. Following the initial parsing and database loading phases, relevant data is periodically distributed throughout the system for specialized processing and reporting 103. As participating consumer activity is qualified for investment account deposit eligibility, invoices are created for submission to benefit sponsors and funds are received from benefit sponsors, or their designated agents and distributed to the investment account custodian(s). In some cases, benefit sponsors may make payments directly to investment account custodian(s) based on information and reports supplied by the system. Finally, the system's reporting and audit functions are also initiated and managed by the host processing system 150. Certain components of the system 104 interface with, accept information from, and distribute information to, outside users including customer support, member access, benefit sponsor access, custodial access and administrative access. To the extent that the Internet is involved, all such exchanges occur through secure firewalls 105 interposed between the input and output of the host system 150.

All information gathered from the various input sources 101 or otherwise generated by the system as data such as data 104 will be stored in a group of relational databases 152 that will service the entire system.

In order to facilitate access to, and distribution of, the data required to manage the processes described herein, the system will leverage, to the greatest extent possible, Internet and electronic telecommunication facilities 156. All data or other information entering the system via the Internet or other telecommunication facilities will be required to pass through secure firewalls 105 in order to assure the security and integrity of the system.

Finally, the system will support all administrative functions 160 required to operate the system and resulting program, including all reporting, accounting and audit and reconciliation functions.

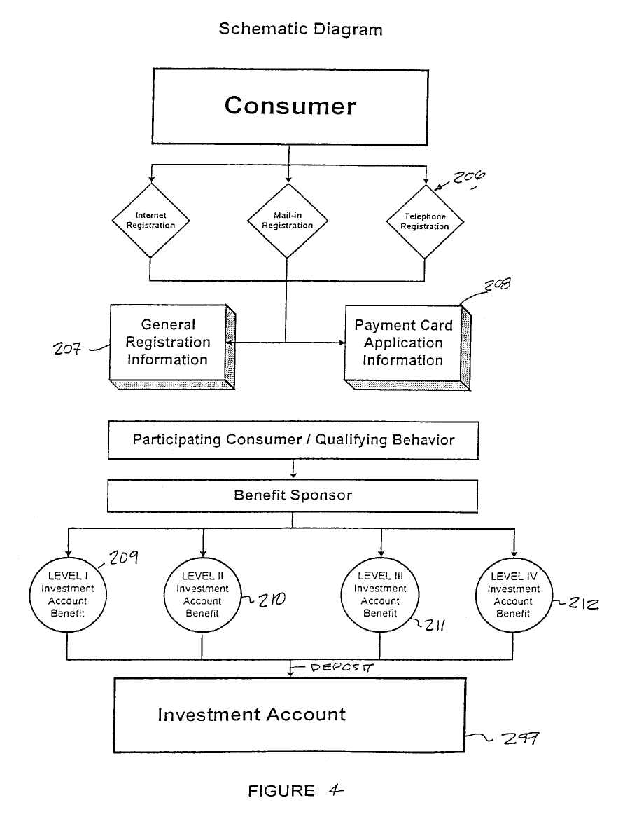

The system, as shown in FIGS. 3 to 6, will be described beginning with the participating consumer registration processes. Referring to FIG. 4, there is shown an overview of the participating consumer registration sub-system, with the associated credit application and investment account benefit eligibility assignment functions.

In general, consumers may register to participate in the program using one of three means 106 shown as: (a) on-line (Internet) registration; (b) telephonic registration; or (c) mail-in registration. (6) During the registration process, consumers will be required to provide certain general information 107 such as name, residential address, e-mail address, phone number and social security number. Consumers will also be asked, but not required, to submit additional demographic information relating to shopping preferences, household income and the like. Consumers will also be advised of, and required to acknowledge, the program's rules and privacy policies. Finally, consumers will be asked to apply for a new payment card issued by a program sponsor and supply the credit information required to process such an application 108.

Participating consumers that apply for and receive a new payment card issued by a program sponsor will receive three levels of investment benefits. These consumers will receive a specified Level I investment account benefit 209 for each dollar spent on the referenced payment card, without regard to whether the merchant accepting the card is also a benefit sponsor. This group of participating consumers will also receive an additional or incremental Level II investment account benefit 210 whenever the card is used to purchase goods and services from a benefit sponsor 211. Finally, this group will also be eligible to receive a Level III investment account benefit for certain qualifying behavior that does not require an expenditure, such as web-surfing, recycling or reading targeted advertisements.

Participating consumers that do not apply for or do not qualify for a new payment card issued by a program sponsor will be asked to register an existing payment card and will receive two levels of investment account benefits. This group will be entitled to receive Level III investment account benefits and Level II investment account benefits at certain other benefit sponsors (if they register a separate payment card).

Certain consumers may also register to participate in the program in connection with their participation in an independent and separate loyalty program, for example a grocery store or frequent dining program. This group will receive the investment account benefits described above, for which they are otherwise eligible, plus a separate Level IV benefit 212 associated with their election to direct all or a portion of the benefit otherwise available to them under the independent and separate program to their investment account 299.

Immediately, upon registration, participating consumers will be entitled to participate in the program and receive investment account benefits commensurate with their level of participation.

In general, a benefit sponsor 201 may be any company or organization that desires to cause or affect a certain consumer behavior in exchange for a payment to the investment account of the participating consumer(s) that engage in the sought after behavior. In most cases, the behavior will be the purchase of a good or service or the use of a specific payment method. In other cases, however, the behavior may not relate to expenditure and instead may relate to an act (for example, web surfing or responding to a consumer survey or recycling). Benefit sponsors may be conventional retail merchants such as supermarkets, department stores, restaurants and the like or even professionals such as lawyers, doctors and accountants. Additionally, benefit sponsors could also be less traditional enterprises such as casinos where the participating consumer could purchase casino credits in a predetermined amount or recyclers who wish to encourage a broader base of consumer participation.

In most cases, benefit sponsors will commence participation in the program by executing an agreement with the program manager establishing, among other things, the consumer behavior(s) sought and the investment account benefit to be paid. In those cases where the benefit sponsor also operates a separate loyalty program, a secure data transmission facility will be established to facilitate appropriate communication between the two programs. Certain benefit sponsors may also wish to offer Level II investment account benefits to those participating consumers that did not apply for or did not receive a new payment card issued by a program sponsor. In these cases, the benefit sponsor and program manager will cooperate to secure the data necessary to fulfill this requirement.

Benefit sponsors may select investment account awards based on a variety of criteria. Typically, merchant's investment account awards will be based on the category of business they are in and the gross profit margins associated with that business segment. Once an investment account award level or group of levels has been selected, the benefit sponsor may add or increase benefits from time to time by coordinating with the program manager. Benefit deletions or decreases, unless part of a pre-announced schedule, will be subject to appropriate participating consumer notification cycles.

Upon commencing participation in the program, benefit sponsor may, subject to strict privacy limitations, communicate with individual participating consumers or groups of participating consumers. All benefit sponsors will be entitled to receive (and in some cases acquire) space within the program's periodic consumer statements, piggyback communications (communications delivered with program or other benefit sponsor communications) and Internet web pages. Other forms of communication with participating consumers will be dependant upon the stated preference(s) of the participating consumers at issue. All benefit sponsors may utilize point of sale promotions, window stickers and the like to advertise participation and attract incremental business.

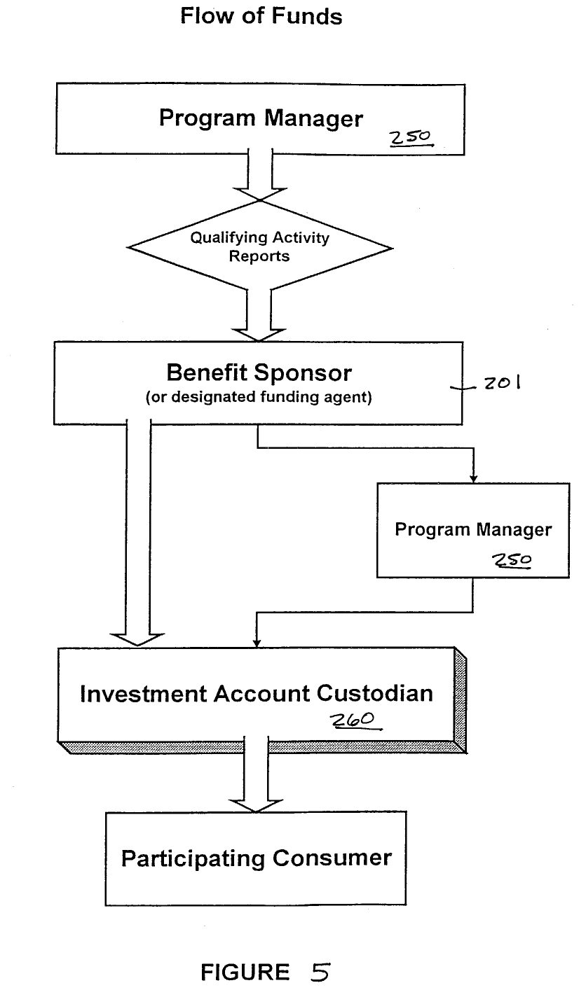

Referring to FIG. 5, there is shown a schematic diagram depicting the flow of funds and investment account benefits through the system is shown. As set forth in the diagram, each benefit sponsor 201 will be invoiced periodically by the program manager 250 for investment account liability and administrative fees. The benefit sponsor will then transfer, or arrange for the transfer of, certain funds to the program manager or the investment account custodian, as the case may be. As appropriate, the program manager will then forward the investment account benefit component of the transferred funds, together with supporting documentation and instructions to the third party fiduciary or custodian 260 holding the investment accounts.

The investment accounts will be held and administered by one or more third-party fiduciaries and invested, managed and disbursed in strict accordance with program rules and guidelines and federal and state income tax laws and regulations relating to the creation and maintenance of tax-deferred investment vehicles as such laws may exist and be modified from time to time.

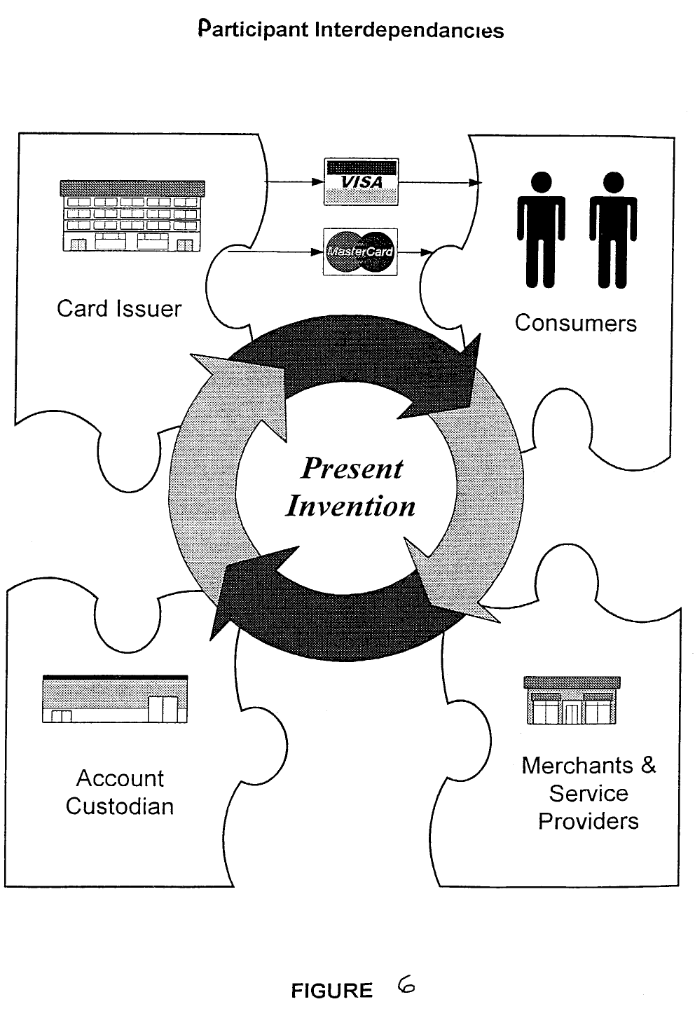

Referring to FIG. 6, a diagrammatic overview of the nature of the interactive and interdependant relationship between that participating consumer and all benefit sponsors is shown. This figure provides a high level view of the synergistic relationships the present invention creates between and among the various participants.

While the invention has been disclosed in connection with the preferred embodiments shown and described in detail herein, various modifications and improvements to the structure, arrangement, proportion, elements, materials and components used in the practice of the invention will become readily apparent to those skilled in the art. Accordingly, the spirit and scope of the present invention is to be limited only by the claims.

We claim:

1. A financial transaction system utilized by a plurality of participating consumers and benefit sponsors comprising:
(a) establishing an investment account for the benefit of a participating consumer;
(b) administering the investment account in a manner that the investment account is entitled to accumulate income and gain on a tax deferred basis;
(c) providing a plurality of benefit sponsors that offer goods and services to the participating consumer;
(d) establishing an authorized payment method for the sale of said goods and services to the participating consumer;
(e) tracking the qualifying activity that results in the participating consumer being entitled to receive a deposit into or a disbursement from said investment account; and
(f) providing a specified benefit to the participating consumer for utilizing the authorized payment method when purchasing goods and services, said benefit comprising a deposit into the participating consumer's investment account.

2. The system of claim 1 further including, reporting on and accounting for the activities that result in the participating consumer being entitled to receive a deposit into, or disbursement from, said investment account.

3. The system of claim 1 further including implementing a deposit into, or disbursement from, said investment account.

4. The system of claim 1 wherein said participating consumer's investment account is established and administered in a manner that the investment account is entitled to accumulate income and gain on a non-tax deferred basis.

5. The system of claim 1 wherein said participating consumer's investment account is pooled with like investment accounts of other participating consumers.

6. The system of claim 1 wherein the investment account is held and administered by a third party acting in a fiduciary capacity with respect to the investment account and the participating consumer.

7. The system of claim 1 wherein an individual may apply to become a participating consumer by providing specified information and wherein each resulting participating consumer is assigned an identification indicia unique to the system.

8. The system of claim 1 including reporting the qualifying activity of the participating consumer to the appropriate benefit sponsor.

9. The system of claim 1 including reporting the investment account activity of the participating consumer to the participating consumer.

10. The system of claim 1 including reporting qualifying activity of the participating consumer to the participating consumer.

11. The system of claim 1 further including providing the participating consumer with directed advertising relating to goods and services and other opportunities offered by benefit sponsors.

12. The system of claim 1 further including providing participating consumers with non-monetary incentives relating to goods and services offered by benefit sponsors.

13. The system of claim 1 further including providing participating consumers with promotions relating to goods and services offered by benefit sponsors.

14. The system of claim 1 further including providing customer service support to participating consumers by established communication systems.

15. The system of claim 1 wherein an individual may obtain information and apply to become a participating consumer by applying via a global communications network.

16. The system of claim 1 wherein an entity may obtain information and apply to become a benefit sponsor by applying via a global communications network.

17. The system of claim 1 wherein a qualifying participating consumer may apply for and use a payment card as the authorized payment method, which payment card is issued by a benefit sponsor.

18. The system of claim 17 wherein the participating consumer is entitled to receive a predetermined investment account benefit for all amounts spent using said payment card, independent of whether the merchant or service provider that accepts the payment card is also a benefit sponsor.

19. The system of claim 17 wherein the participating consumer is entitled to receive an incremental predetermined investment account benefit for all amounts spent using such payment card to purchase goods and services from a benefit sponsor.

20. The system of claim 17 wherein the participating consumer is entitled to receive a predetermined investment account benefit for all amounts spent purchasing goods and services from certain designated benefit sponsors.

21. The system of claim 1 wherein a participating consumer may register and use a payment card as the authorized payment method, which payment card is not issued by a benefit sponsor.

22. The system of claim 1 wherein said authorized payment method utilized by the participating consumer is selected from the group consisting of credit cards, on-line debit cards, off-line debit cards, travel and entertainment cards, smart cards, chip cards, stored value cards, cash, paper checks, electronic checks, truncated checks, an Internet wallet, electronic wallet or cyber-currency.

23. The system of claim 15 wherein a participating consumer may apply for a payment card issued by a benefit sponsor by submitting the required information through a global communications web page operated by or on behalf of a benefit sponsor.

24. The system of claim 1 wherein a participating consumer that also participates in an independent shopping or loyalty program may designate a predetermined portion of the benefits available to such participating consumer under the independent program be directed, as a deposit, into such participating consumer's investment account.

25. The system of claim 24 further providing tracking, reporting and accounting for the investment account deposits resulting from a participating consumer's participation in said independent program.

26. The system of claim 25 wherein the benefit sponsor is a manufacturer of the predetermined good or service.

27. The system of claim 25 wherein the benefit sponsor is a distributor of the predetermined good or service.

28. The system of claim 25 wherein the system has access to transaction data such that the system can track and account for the participating consumer's purchase of the predetermined good or service.

29. The system of claim 28 wherein said data is SKU data.

30. The system of claim 29 wherein said data is Level II data.

31. The system of claim 1 wherein a participating consumer receives an incremental investment account benefit in connection with the purchase of a predetermined good or service.

32. The system of claim 1 wherein the participating consumer is entitled to receive an incremental investment account benefit by engaging in designated qualifying activity not requiring the purchase of goods or services.

33. The system of claim 1 wherein the participating consumer may designate a third party as the beneficiary of the participating consumer's investment account.

34. The system of claim 1 further providing an audit and reconciliation function which does not provide or permit an investment account benefit for goods and services that are returned or subject to payment dispute, including chargeback and retrieval processes.

35. The system of claim 1, wherein benefit sponsors fund the participating consumer's investment account benefits via electronic transfer means.

36. The system of claim 35 wherein said electronic transfer means is the Automated Clearing House (ACH).

37. The system of claim 35 wherein said electronic means comprises the Automated Clearing House.

38. The system of claim 1, wherein designated third parties, acting on behalf of and at the direction of benefit sponsors, fund the participating consumer's investment account benefits via electronic means.

39. The system of claim 1 wherein selected information relating to the spending habits and preferences of participating consumers is accumulated and maintained in a secure electronic environment for use in connection with administering the system and for the exclusive benefit of the participating consumer and benefit sponsor.

40. The system of claim 1, wherein a participating consumer may view his or her investment account and qualifying activity status using wireless technologies selected from a group consisting of PDA's (personal digital assistants), cellular, digital or satellite communication devices.

41. The system of claim 1, wherein a participating consumer may initiate permitted investment account activities using wireless technologies, selected from a group consisting of PDA's (personal digital assistants), cellular, digital or satellite communication devices.

42. The system of claim 1 wherein a benefit sponsor may send participating consumers information via wireless communications.

43. The system of claim 28 wherein said statements are piggyback communications accompanying other communications.

44. The system of claim 1 wherein each benefit sponsor may offer a customized account benefit to a participating consumer as a result of the participating consumer's purchase of certain goods or services or other qualifying activity.

45. A computer-based system operated for the benefit of a plurality of participating consumers and benefit sponsors comprising:
(a) means for acquiring required data for each participating consumer;
(b) means for acquiring required data for each benefit sponsor;
(c) means for acquiring the data required to track the qualifying activity of each participating consumer;
(d) means for storing the data described in (a) through (c);
(e) means for processing the data described in (a) through (c) such that investment account benefits are calculated;
(f) means for reporting the results of (e) to participating consumers, benefit sponsors and investment account custodians;
(g) means for responding to inquiries from participating consumers;
(h) means for responding to inquiries from benefit sponsors;
(i) means for acquiring the data necessary to, track, approve, and report on an addition to or a disbursement from an investment account;
(j) means for implementing an addition to or a disbursement from an investment account; and
(k) means in (a) through (j) comprised of coded instructions that are executed by a group of computers.

46. The system of claim 45 wherein said instruction comprise a plurality of machine readable instructions which, when executed by a discrete group of computers and related electronic devices, operating in tandem, causes such computers to perform each of the steps as set forth in (a) through (j).

47. The system of claim 45 wherein a comprehensive and fully integrated computer and global communication system implements, operates and administers the system.
